(19) United States
(12) Patent Application Publication
(10) Pub. No.: US 2006/0237929 A1
(43) Pub. Date: Oct. 26, 2006

(54) Office machine

(75) Inventor: Tetsuya Taguchi, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: KYOCERA MITA CORPORATION, Osaka (JP)

(21) Appl. No.: 11/409,592

(22) Filed: Apr. 24, 2006

(30) Foreign Application Priority Data
Apr. 26, 2005 (JP) JP 2005-127875

(51) Int. Cl. B62B 3/00

(52) U.S. Cl. 280/47.34

(57) ABSTRACT

An office machine includes a housing body, a bearing unit secured to the housing body and a caster wheel supported to the bearing unit to be rotatable about a horizontal axis. The bearing unit is secured to a bottom plate forming a lower face of the housing body. The bottom plate defines an opening, through which the caster wheel is introduced to a position upwardly of the bottom plate to be supported to the bearing unit.

### CROSS-REFERENCE TO RELATED APPLICATION

The present application claims priority based on the Japanese Patent Application JP2005-127875 filed by the present applicant in Japan on Apr. 26, 20005.

### BACKGROUND OF THE INVENTION

1. Field of the Invention

The present invention relates to an office machine such as an image forming apparatus including a copier, a printer, etc. or a movable rack, having caster wheels supported to bearing units secured to a housing body to be rotatable about horizontal axes.

2. Prior Art

In the conventional office machines of the above-noted type, bearing units are secured to lower end faces of corner portions of the housing body extending along the vertical direction of the housing body and wheels (caster wheels) are rotatably supported to these bearing units (see e.g. Japanese Patent Application “Kokai” No. 9-304985 (referred to as “First Conventional Technique”, hereinafter)), or, upwardly recessed faces are formed in a bottom plate forming the lower end face of the housing body and bearing units are secured to these recessed faces for rotatably supporting wheels (see e.g. Japanese Patent Application “Kokai” No. 6-175419 (referred to as “Second Conventional Technique”, hereinafter)).

In the case of First Conventional Technique, as the bearing units are fixed to the lower end faces of the housing body corner portions, there is an advantage of the ability to support the wheels to the bearing units, without requiring any special modifications in the housing body. However, when wheels of greater radius advantageous for smooth transporting of the machine are employed, this results in corresponding increase in the supporting height of the housing body. As a result, the installment space may increase and the maneuverability of the machine can be impaired.

In the case of Second Conventional Technique, the bearing units are secured to the recessed faces formed in the lower face of the housing body. Hence, even if wheels of larger radius are supported to the bearings, it is relatively easy to maintain the supporting height of the housing body low. In this respect, this construction is advantageous. On the other hand, this construction suffers the drawback of requiring a troublesome machining operation such as bending or reducing work to form the recessed faces in the lower face of the housing body.

The present invention has been made in view of the above-described state of the art. The primary object of the present invention is to allow reduction in the supporting height of the housing body through a simple modification of the housing body, even when wheels of larger radius are supported to bearing units. A further object of the invention is to provide an office machine capable of maintaining sufficient mounting strength of the bearing units to the housing body, though requiring only easy modification.

### SUMMARY OF THE INVENTION

According to a first characterizing feature of the present invention, an office machine comprises: a housing body; a bearing unit secured to the housing body; and a caster wheel supported to the bearing unit to be rotatable about a horizontal axis; wherein said bearing unit is secured to a bottom plate forming a lower face of the housing body, the bottom plate defining an opening, and said caster wheel is introduced through said opening to a position upwardly of the bottom plate to be supported to the bearing unit.

With the above-described construction, the bearing unit is secured to a bottom plate forming a lower face of the housing body. Hence, the bearing unit can be secured easily, without requiring any special modification of the housing body. Further, the bottom plate defines an opening, through which the wheel is introduced to a position upwardly of the bottom plate to be supported to the bearing unit. Therefore, with the simple modification of defining an opening in the bottom plate, the supporting height of the housing body can be maintained low, even when a wheel with a large radius is supported to the bearing unit.

According to a second characterizing feature of the present invention, an office machine comprises: a housing body; a bearing unit secured to the housing body; and a caster wheel supported to the bearing unit to be rotatable about a horizontal axis; wherein said bearing unit is secured to a side plate forming a side face of the housing body, a bottom plate forming a lower face of the housing body defining an opening, and said caster wheel is introduced through said opening to a position upwardly of the bottom plate to be supported to the bearing unit.

With the above-described construction, the bearing unit is secured to a side plate forming a side face of the housing body. Hence, the bearing unit can be secured easily, without requiring any special modification of the housing body. Further, the bottom plate forming a lower side of the housing body defines an opening, through which the wheel is introduced to a position upwardly of the bottom plate to be supported to the bearing unit. Therefore, with the simple modification of defining an opening in the bottom plate, the supporting height of the housing body can be maintained low, even when a wheel with a large radius is supported to the bearing unit.

According to a third and a fourth characterizing feature of the present invention, an inner peripheral edge of said opening is folded over to form a flange portion.

With the above construction, the inner peripheral edge of the opening defined in the bottom plate is folded over to form a flange portion. This flange portion helps to increase the rigidity of the opening, thus improving the durability. Hence, this construction allows the present invention to be applied to an office machine having a greater weight.

According to a fifth and a sixth characterizing feature of the present invention, an inner peripheral edge of said opening is folded over to form a flange, which, constitutes, together with a side plate forming a side face of the housing body, a stabilizing mechanism for stabilizing the bearing unit from a lateral side thereof.

With the above-described construction, with the provision of the stabilizing mechanism for stabilizing the bearing unit from a lateral side thereof, it is possible to stabilize the rotation of the wheel, thus preventing a damage or an accident in the course of the movement of the office machine.

According to a seventh characterizing feature of the present invention, a portion of said side plate is cut and raised outwardly to form a tongue-like extension of the housing body, said bearing unit being secured from a perpendicularly upper direction, with the bearing unit being placed in face contact with the housing body tongue-like extension.

The housing body tongue-like extension is provided for mounting the bearing unit and this extension is obtained by the simple operation of cutting and raising outwardly a portion of the side plate. Hence, this can be manufactured inexpensively, without requiring any complicated or high precision work.

Further, as the bearing unit is secured from a perpendicularly upper direction, with the bearing unit being placed in face contact with the housing body tongue-like extension, a uniform force can be applied from the bearing unit to the tongue-like extension. Hence, the office machine can be stabilized in its posture.

Further, since the securing is realized under the face contact condition described above, the bearing unit and the housing body tongue-like extension can be combined together or integrated to provide higher rigidity, so there will occur no significant lateral displacement between the bearing unit and the housing body tongue-like extension. Accordingly, it is possible to minimize a bending force which may be applied from the bearing unit to the side plate of the housing body. As a result, the posture of the office machine can be stabilized, and the durability of the office machine can be improved also.

### BRIEF DESCRIPTION OF THE DRAWINGS

FIG. 1 is a perspective view of an image forming apparatus (a post processing unit thereof),

FIG. 2 are (a) a perspective view of a bottom support unit as seen from a top side, (b) a perspective view of the bottom support unit as seen from a bottom side,

FIG. 3 are (a) a vertical section of principal portions prior to attachment of bearing units, (b) a section of the principal portions after the attachment of the bearing units, and

FIG. 4 is a vertical section of the principal portions for illustrating a stress applied to the bearing units.

### DETAILED DESCRIPTION OF THE INVENTION

Preferred embodiments of the invention will be described in details with reference to the accompanying drawings.

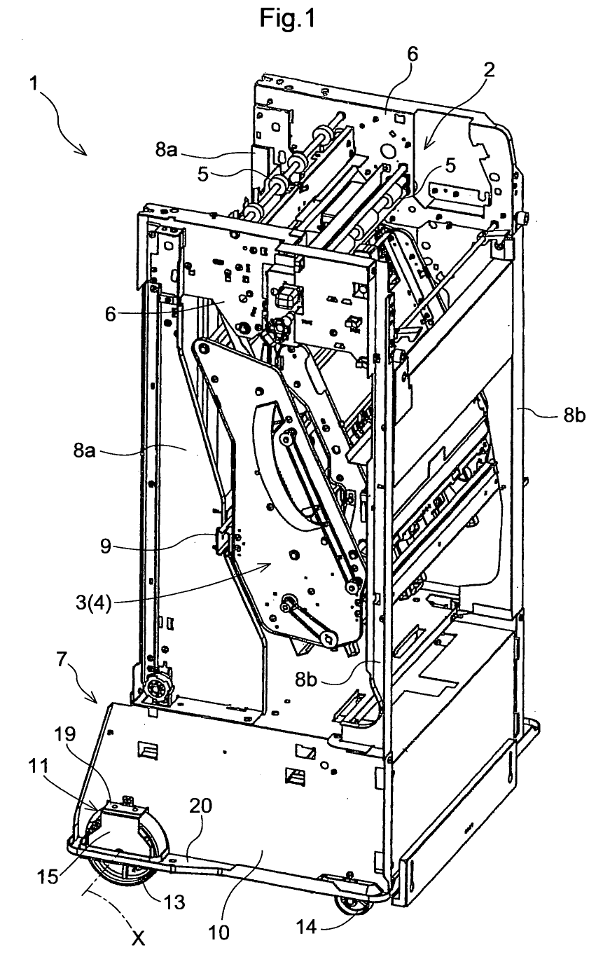

FIG. 1 shows a post processing unit 1 included in an image forming apparatus such as a photocopier, a printer or the like, as an example of an office machine relating to the invention. A paper carrying-in/out device 2 is capable of carrying in or carrying out an image-formed paper sheet discharged from a paper discharge outlet provided in an image forming section for copying an original document image on a paper sheet. As an example of the post processing unit, an intermediate tray 4 includes a stapling device 3 for stapling a plurality of image-formed paper sheets discharged from the paper carrying-in/out device 2 and a bottom support unit 7 is provided downwardly of the intermediate tray 4.

The paper carrying-in/out device 2 comprises a unit integrating e.g. a set of transport rollers 5 supported to a pair of right and left side plates 6 for carrying in each image-formed paper sheet discharged from the image forming section into the post processing unit 1 or carrying out the introduced image-formed paper sheet to the stapling device 3 or to a paper discharge tray (not shown), etc.

The paper carrying-in/out device 2 and the bottom support unit 7 are fixed together in a vertically spaced relationship through a plurality of struts 8a, 8b. And, within the space between the paper carrying-in/out device 2 and the bottom support unit 7, there is assembled the intermediate tray 4 (stapling device 3) to be projectable and withdrawable along a guide frame 9 toward a lateral side of the machine body.

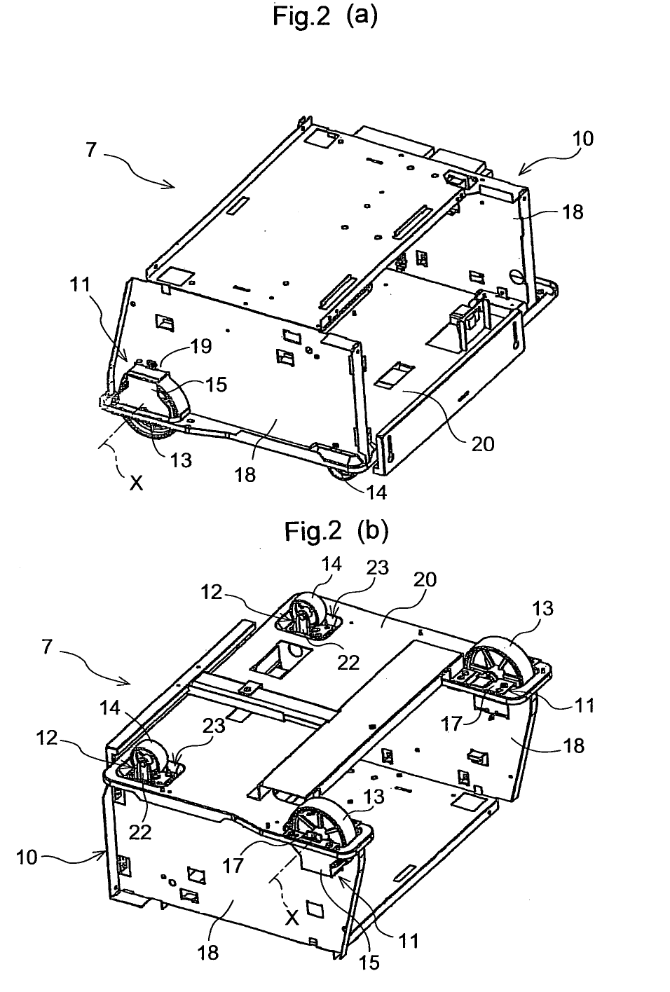

Referring to the bottom support unit 7, as shown also in FIG. 2, bearing units 11, 12 are secured to front and rear and right and left portions of a housing body 10 formed of sheet metal. And, caster wheels 13, 14 are supported to the respective bearing units 11, 12 to be rotatable about horizontal axes X. The housing body 10 is capable of accommodating therein e.g. a folding device for folding an image-formed paper sheet into two, if necessary.

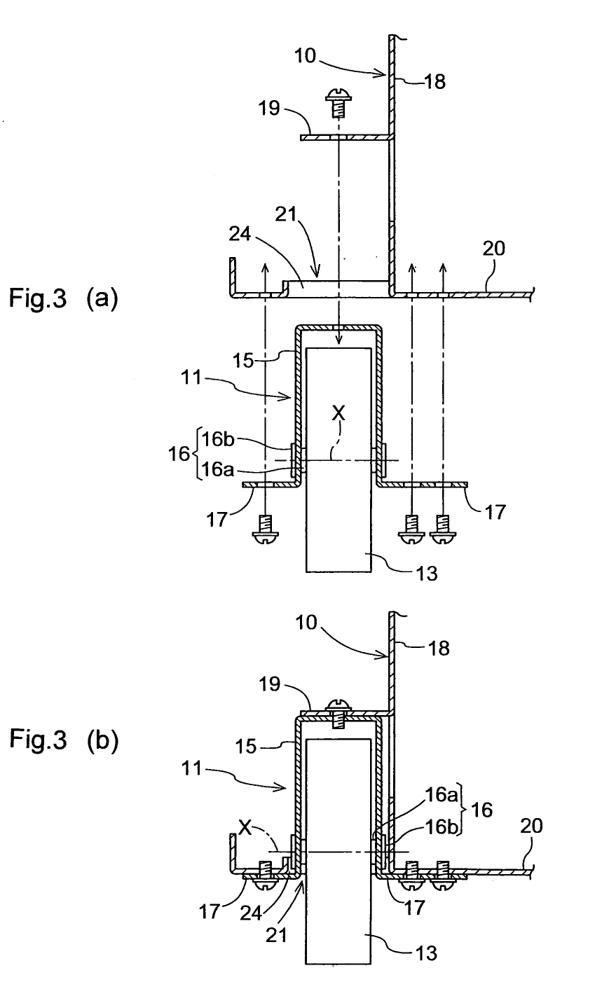

Of the above-described bearing units 11, 12, for each one of the bearing units 11 disposed at the right and left front portions adjacent the paper discharge tray, as shown also in FIG. 3, a bearing portion 16 is provided at a lower end of a wheel supporting frame 15 which is formed like a downwardly oriented angular hook shaped member. Further, a pair of tongue-like extensions 17 of the frame side are provided on the right and left sides thereof The bearing portion 16 consists essentially of a shaft portion 16a for rotatably supporting the wheel 13 to the wheel supporting frame 15 and a securing portion 16b for securing the shaft portion 16a to the wheel supporting frame 15. Therefore, there will not occur inadvertent detachment of the bearing portion 16 from the wheel supporting frame 15.

Each frame-side tongue-like extension 17 can be formed by bending an end of the wheel supporting frame 15 into an L-shape. Hence, this can be manufactured inexpensively, without requiring any special work.

Further, a portion of a side plate 18 forming a side face of the housing body 10 is cut and raised outwardly to form a tongue-like extension 19 of the housing body. And, an opening 21 is defined in a bottom plate 20 forming a lower face of the housing body 10 adjacent the side plate. This opening 21 has its inner peripheral edge folded over to form a flange portion 24. With this formation of the flange portion 24 at the inner peripheral edge of the opening 21, the flange portion 24 provides additional rigidity to the opening 21, thus improving its durability. As a result, this construction can be used for an office machine-of a greater weight.

Then, the wheel supporting frame 15 is introduced through the opening 21 to a position upwardly of the bottom plate 20 and then screw-fixed to the housing body tongue-like extension 19. Further, the right and left frame side tongue-like extensions 17 are screw-fixed to the lower face of the bottom plate 20, thus securing the bearing unit 11 to the bottom plate 20 and also to the side plate 18. And, a large wheel 13 is introduced through the opening 21 to the position upwardly of the bottom plate 20 to be supported to the bearing unit 11. In this, as the bearing unit 11 is surrounded laterally with the flange portion 24 and the side plate 18, the bearing unit 11 can be maintained under a stable posture. That is, the flange portion 24 and the side plate 18 together function also as a stabilizing mechanism for laterally stabilizing the bearing unit 11. With this construction, the rotation of the wheel 13 can be stabilized also and damage, accident or the like during movement of the office machine 1 can be effectively prevented.

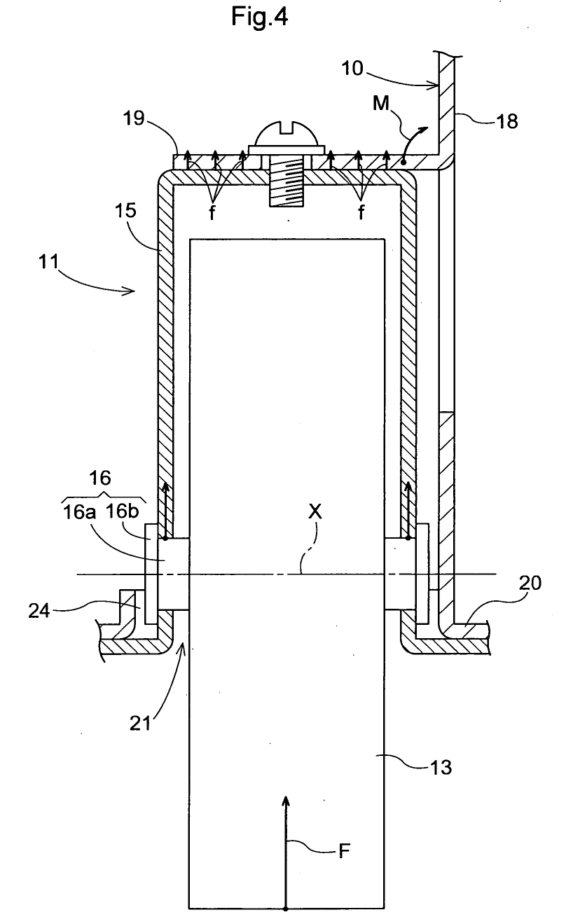

Incidentally, as shown in FIG. 3, if the securing of the bearing unit 11 to the side plate 18 is effected by screw-fixing of the bearing unit 11 from the perpendicularly upward direction under a face contact condition to the housing body tongue-like extension 19, there is obtained an advantage of rendering uniform the force applied to the housing body tongue-like extensions 19. This will be described next in greater details with reference to FIG. 4.

For instance, when a stress F (arrow F) is applied to the wheel 13, this stress F will be distributed to the opposed shaft portions 16a and then transmitted via the wheel supporting frame 15 to be applied as distributed stress components f (arrow f) to the housing body tongue-like extension 19. As these distributed stress components f are generated over the entire upper face of the wheel supporting frame 15 which is placed under the face contact with the housing body tongue-like extension 19, there will occur no localized stress application to this housing body tongue-like extension 19.

Further, if the securing is effected under the face contact condition described above, the wheel supporting frame 15 and the housing body tongue-like extension 19 can be integrated together to provide greater rigidity, so that there will occur no significant lateral displacement between the bearing unit 11 and the housing body tongue-like extension 19. For this reason, it is possible to minimize a bending force (arrow M) which may be applied from the bearing unit 11 to the side plate 18 of the housing body 10. As a result, the posture of the office machine 1 is stabilized and the durability of the office machine 1 is improved.

Incidentally, of the bearing units 11, 12, regarding the right and left rear bearing units 12 disposed away from the paper discharge tray, there is provided a wheel supporting frame 22 which is formed like a downwardly oriented angular hook shaped member. And, an upper portion of this frame 22 is introduced into a recessed portion 23 which is formed as an upwardly oriented recess in the bottom plate 20 by a reducing work of the plate to be rotatable about a vertical axis.

### Other Embodiments

1. In the office machine according to the present invention, the bearing units can be secured only to the bottom plate forming the lower face of the housing body.

2. In the office machine according to the present invention, the bearing units can be secured only to the side plates forming the side faces of the housing body.

3. In the office machine according to the present invention, the wheel can be introduced through the opening to a position upwardly of the bottom plate and inside the housing body to be supported to the bearing unit.

4. In the office machine according to the present invention, the bearing unit can be secured to be pivotable about a vertical axis.

5. The office machine according to the present invention can be a movable rack, a shredder machine, etc.

1. An office machine comprising:
a housing body;
a bearing unit secured to the housing body; and
a caster wheel supported to the bearing unit to be rotatable about a horizontal axis;
wherein said bearing unit is secured to a bottom plate forming a lower face of the housing body, the bottom plate defining an opening, and said caster wheel is introduced through said opening to a position upwardly of the bottom plate to be supported to the bearing unit.

2. An office machine comprises:
a housing body;
a bearing unit secured to the housing body; and
a caster wheel supported to the bearing unit to be rotatable about a horizontal axis;
wherein said bearing unit is secured to a side plate forming a side face of the housing body, a bottom plate forming a lower face of the housing body defining an opening, and said caster wheel is introduced through said opening to a position upwardly of the bottom plate to be supported to the bearing unit.

3. The office machine according to claim 1, wherein an inner peripheral edge of said opening is folded over to form a flange portion.

4. The office machine according to claim 2, wherein an inner peripheral edge of said opening is folded over to form a flange portion.

5. The office machine according to claim 1, wherein an inner peripheral edge of said opening is folded over to form a flange, which, constitutes, together with a side plate forming a side face of the housing body, a stabilizing mechanism for stabilizing the bearing unit from a lateral side thereof.

6. The office machine according to claim 2, wherein an inner peripheral edge of said opening is folded over to form a flange, which, constitutes, together with a side plate forming a side face of the housing body, a stabilizing mechanism for stabilizing the bearing unit from a lateral side thereof.

7. The office machine according to claim 2, wherein a portion of said side plate is cut and raised outwardly to form a tongue-like extension of the housing body, said bearing unit being secured from a perpendicularly upper direction, with the bearing unit being placed in face contact with the housing body tongue-like extension.
